(19) United States
(12) Patent Application Publication
(10) Pub. No.: US 2026/0119218 A1
(43) Pub. Date: Apr. 30, 2026

(54) CXL DEVICE FOR CONTAINER VIRTUALIZATION-BASED NDP AND OPERATING METHOD THEREOF

(71) Applicant: Panmnesia Inc., Daejeon (KR)

(72) Inventor: Mi Ryeong KWON, Daejeon (KR)

(73) Assignee: Panmnesia Inc., Daejeon (KR)

(21) Appl. No.: 19/367,154

(22) Filed: Oct. 23, 2025

(30) Foreign Application Priority Data
Oct. 24, 2024 (KR) 10-2024-0146743

(51) Int. Cl. G06F 9/455; G06F 13/42

(52) U.S. Cl. CPC G06F 9/455; G06F 13/4282; G06F 2009/45579; G06F 2213/0026

(57) ABSTRACT

An operating method of a compute express link (CXL) device according to an embodiment includes receiving an Ethernet frame including data including information on a user command from a host device, based on a CXL protocol. The operating method includes running a container using at least one of a first runtime software module and a second runtime software module to perform an operation corresponding to the user command.

### CROSS-REFERENCE TO RELATED APPLICATIONS

This application claims priority to Korean Patent Application No. 10-2024-0146743, filed on Oct. 24, 2024, in the Korean Intellectual Property Office, the entire disclosure of which is incorporated herein by reference for all purposes.

### BACKGROUND

### 1. Field

The disclosure relates to a compute express link (CXL) device for container virtualization-based near data processing (NDP) and an operating method thereof.

### 2. Description of the Related Art

Compute express link (CXL) is a high-speed interconnect standard for transferring data between computing system components. By connecting memory-containing endpoints to a host via CXL, computing systems may provide users with large memory capacity.

CXL may provide cache coherence to a computing system. Cache coherence may be a function for managing caches of various computing devices (e.g., central processing units (CPUs), graphics processing units (GPUs), and/or field programmable gate arrays (FPGAs)) to maintain up-to-date information when sharing data. The computing system may prevent data inconsistency through cache coherence provided by the CXL.

Near data processing (NDP) may be a technology for performing operations (or computations) on data stored in a memory device or storage device within that device. For example, NDP may be used for artificial intelligence (AI) applications and cloud computing.

The above information is presented as related art only to assist with an understanding of the disclosure. None of the above may be applicable as prior art with regard to the disclosure.

### SUMMARY

An embodiment may provide a method of applying container-based operating system-level virtualization for operations in a compute express link (CXL) memory pool.

An embodiment may provide high processing performance for applications requiring near data processing (NDP).

According to an aspect of an embodiment, there is provided a CXL device including at least one processor including processing circuitry and at least one memory storing instructions. The instructions, when executed by the at least one processor individually or collectively, cause the CXL device to receive data including information on a user command from a host device. The instructions, when executed by the at least one processor individually or collectively, cause the CXL device to run a container using at least one of a first runtime software module and a second runtime software module to perform an operation (or a computation) corresponding to the user command.

The container may use an emulator software module for emulating a function of an operating system of the host device to perform the operation corresponding to the user command.

The CXL device may provide memory resources of the CXL device to the host device based on CXL.

The CXL device may communicate with the host device via Ethernet based on a CXL protocol.

The instructions, when executed by the at least one processor individually or collectively, may cause the CXL device to receive an Ethernet frame including data including the information on the user command from the host device, based on the CXL protocol.

Each of the first runtime software module, the second runtime software module, and the emulator software module may be firmware.

The emulator software module may provide a system call function for managing a region of the memory allocated to the container.

The CXL device may further include non-volatile memory configured to store data.

The instructions, when executed by the at least one processor individually or collectively, may cause the CXL device to perform the operation corresponding to the user command using the data stored in the non-volatile memory via the container.

The instructions, when executed by the at least one processor individually or collectively, may cause the CXL device to transmit result data generated from the operation corresponding to the user command to the host device.

The CXL device may be selected by the host device as a device to run the container for the user command among a plurality of CXL devices connected to the host device based on Ethernet.

The CXL device may support a CXL.mem protocol.

The emulator software module may include a software driver for transmitting the result data generated from the operation corresponding to the user command to the host device via an Ethernet frame.

The instructions, when executed by the at least one processor individually or collectively, may cause the CXL device to pull a container image via the first runtime software module. The instructions, when executed by the at least one processor individually or collectively, may cause the CXL device to run the container using the container image via the second runtime software module.

According to an aspect of an embodiment, there is provided a computing system based on CXL including a CXL device and a host device communicating with the CXL device via Ethernet based on a CXL protocol. The CXL device includes at least one processor including processing circuitry and at least one memory storing instructions. The instructions, when executed by the at least one processor individually or collectively, cause the CXL device to receive data including information on a user command from a host device. The instructions, when executed by the at least one processor individually or collectively, cause the CXL device to run a container using at least one of a first runtime software module and a second runtime software module to perform an operation corresponding to the user command. The container may use an emulator software module for emulating a function of an operating system of the host device to perform the operation corresponding to the user command. The host device includes at least one processor including processing circuitry and at least one memory storing instructions. The instructions, when executed by the at least one processor individually or collectively, cause the host device to acquire a user command. The instructions, when executed by the at least one processor individually or collectively, cause the host device to select a CXL device to run a container to process the user command among a plurality of CXL devices communicating with the CXL device via Ethernet based on a CXL protocol. Respective internet protocol (IP) addresses of the plurality of CXL devices may be different from each other.

According to an aspect of an embodiment, there is provided an operating method of a CXL device including receiving an Ethernet frame including data including information on a user command from a host device, based on a CXL protocol. The operating method includes running a container using at least one of a first runtime software module and a second runtime software module to perform an operation corresponding to the user command. The container may use an emulator software module for emulating a function of an operating system of the host device to perform the operation corresponding to the user command.

The CXL device may provide memory resources of the CXL device to the host device based on CXL.

Each of the first runtime software module, the second runtime software module, and the emulator software module may be firmware.

The emulator software module may provide a system call function for managing a memory region of the CXL device allocated to the container.

The CXL device may further include non-volatile memory configured to store data.

The operating method may further include performing the operation corresponding to the user command using the data stored in the non-volatile memory via the container. The operating method may further include transmitting result data generated from the operation corresponding to the user command to the host device.

The CXL device may support a CXL.mem protocol.

The emulator software module may include a software driver for transmitting result data generated from the operation corresponding to the user command to the host device via an Ethernet frame.

According to an embodiment, a non-transitory computer-readable storage medium may store instructions that, when executed by a processor, cause the processor to perform the method.

The technical aspects are not limited to the aforementioned aspects, and additional aspects of embodiments will be set forth in part in the description which follows and, in part, will be apparent from the description, or may be learned by practice of the disclosure.

### BRIEF DESCRIPTION OF THE DRAWINGS

With regard to the description of the drawings, the same or similar reference numerals may be used for the same or similar components.

FIG. 1 is a diagram illustrating an issue of compute express link (CXL)-based near data processing (NDP).

FIG. 2 is a diagram illustrating a CXL system according to an embodiment.

FIG. 3 is a diagram illustrating endpoint types according to an embodiment.

FIGS. 4 and 5 are diagrams illustrating a connection between a host and an endpoint according to an embodiment.

FIG. 6 is a schematic block diagram illustrating an endpoint according to an embodiment.

FIG. 7 is a diagram illustrating a software module of a host and a software stack of an endpoint according to an embodiment.

FIG. 8 is a diagram illustrating an example of an operation using a system according to an embodiment.

FIG. 9 is a schematic block diagram illustrating a host according to an embodiment.

FIG. 10 is a flowchart illustrating an operation of an endpoint according to an embodiment.

FIG. 11 is a flowchart illustrating an operation of a host according to an embodiment.

### DETAILED DESCRIPTION

The following detailed structural or functional description is provided as an example only and various alterations and modifications may be made to the embodiments described herein. Accordingly, the embodiments described herein are not intended to limit the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly, the second component may also be referred to as the first component.

It will be understood that when a component is referred to as being “connected to” or “coupled to” another component, the component may be directly connected or coupled to the other component or intervening components may be present.

As used herein, the singular forms are intended to include the plural forms as well, unless the context clearly indicates otherwise. As used herein, each of such phrases as “A or B”, “at least one of A and B”, “at least one of A or B”, “A, B or C”, “at least one of A, B and C”, and “at least one of A, B, or C”, may include any one of, or all possible combinations of the items enumerated together in a corresponding one of the phrases. It should be further understood that the terms “comprises/comprising” and/or “includes/including” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. It should be understood that the following embodiments may be referenced, borrowed, or combined with each other. When describing the embodiments with reference to the accompanying drawings, like reference numerals refer to like components, and any repeated description related thereto will be omitted. In the present disclosure, an endpoint may be a compute express link (CXL) device.

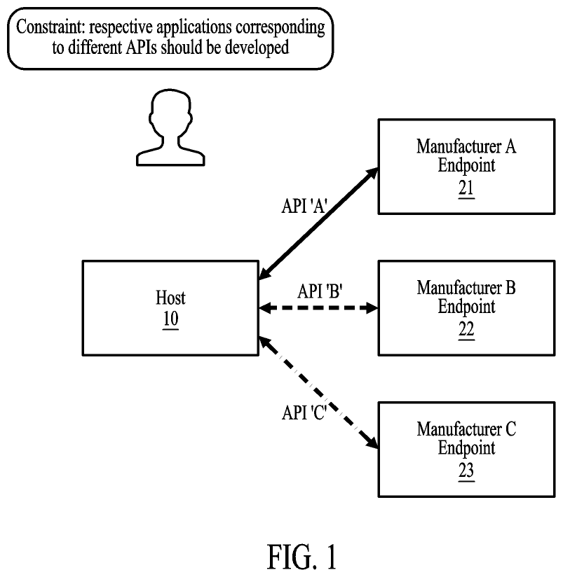

FIG. 1 is a diagram illustrating an issue of CXL-based near data processing (NDP).

Referring to FIG. 1, CXL may be used for NDP.

For example, when three endpoints 21 to 23 are connected to a host 10 via CXL, the host 10 may offload a computation (or operation) required for an application to at least one endpoint. To offload the computation, detailed information on an endpoint may be required, but detailed information (e.g., hardware structure or detailed software structure) of an endpoint may not typically be disclosed. In place of this information, an endpoint manufacturer may provide a limited application programming interface (API) for interfacing with the host, and a user may offload the computation required for an application to the endpoint using the provided API. This approach may degrade user experience. For example, when an API ‘A’ of the endpoint 21, an API ‘B’ of the endpoint 22 and an API ‘C’ of the endpoint 23 are different, a user may be required to write (or develop) an application (or code) corresponding to each API. For example, an application developed based on API′A′ of the endpoint 21 may not be used to offload a computation to the endpoint 22.

An embodiment of the disclosure may effectively process NDP required for applications via operating system-level virtualization in a CXL system.

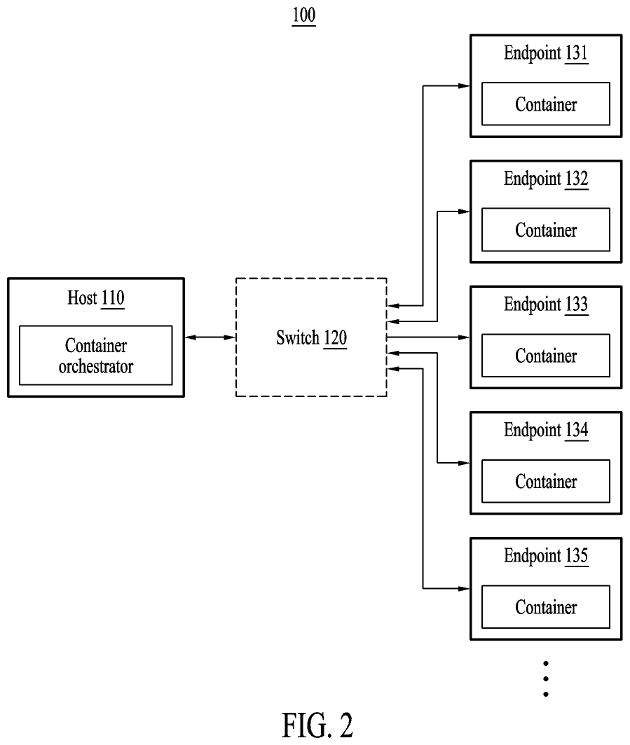

FIG. 2 is a diagram illustrating a CXL system according to an embodiment.

Referring to FIG. 2, according to an embodiment, a CXL system 100 may include a host 110, at least one of endpoints 131 to 135, and a CXL switch 120. The CXL system 100 may use operating system-level virtualization to perform computations. The CXL system 100 may provide to a user a consistent execution environment regardless of hardware specifications and/or application type of an endpoint via a container based on operating system-level virtualization.

In an embodiment, the CXL switch 120 may be omitted from the CXL system 100. For example, when the number of endpoints connected to the host 110 is small, the CXL system 100 may not include the CXL switch 120. For example, when the host 110 includes a hardware component (e.g., peripheral component interconnect express (PCIe) lane) configured to support communication with all of a small number of endpoints (e.g., four endpoints) of the CXL system 100, the host 110 and each endpoint may be connected to each other without the CXL switch 120. For example, when the host 110 provides functions of the CXL switch 120, the CXL system 100 may not include the CXL switch 120.

The host 110 may be connected to the at least one of the endpoints 131 to 135 based on CXL. The host 110 may manage respective containers run by the at least one of the endpoints 131 to 135 using a container orchestrator. The container orchestrator may be a software module for managing a containerized application. For example, the container orchestrator may be, but is not limited to, Kubernetes, Google Kubernetes Engine, Azure Kubernetes Service, Apache Mesos, or Nomad. The container orchestrator may recognize each of the host 110 and the at least one of the endpoints 131 to 135 as a node. The node may refer to a computing resource (e.g., hardware device) configured to run a container.

In an operating system-level virtualization environment, Ethernet may be used for communication between nodes. According to an embodiment of the disclosure, CXL-based Ethernet may be used for the communication between nodes (e.g., a host and endpoints).

The switch 120 (e.g., CXL switch) may connect the at least one of the endpoints 131 to 135 to a host or connect the at least one of the endpoints 131 to 135 to each other. The switch 120 may manage data paths between the host 110 and the at least one of the endpoints 131 to 135.

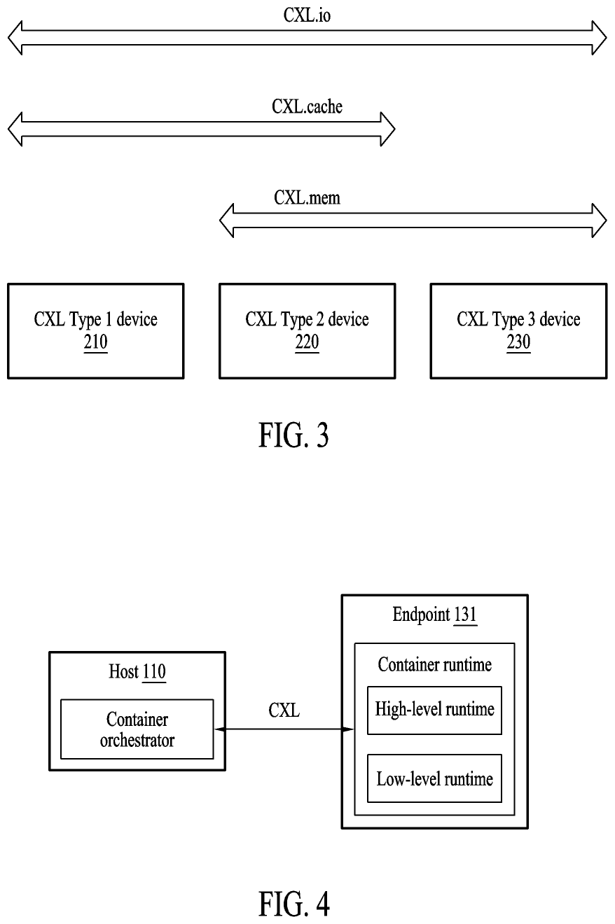

The at least one of the endpoints 131 to 135 may each include host-managed device memory (HDM). The HDM may refer to memory managed by a host. The at least one of the endpoints 131 to 135 may each be a type 2 CXL device or type 3 CXL device. The type of CXL device is described in detail with reference to FIG. 3.

The host 110 and/or at least one of the endpoints 131 to 135 may respectively run a container. The container may be a software module (e.g., Docker) or technology for packaging an application and a library, configuration, runtime, and/or dependency required to run the application so that the application runs in the same execution environment.

Hereinafter, for ease of description, the disclosure is described based on a single endpoint 131 connected to the host 110.

FIG. 3 is a diagram illustrating endpoint types according to an embodiment.

Referring to FIG. 3, according to an embodiment, a CXL device (e.g., the at least one of the endpoints 131 to 135 of FIG. 2) may be a CXL Type 1 device 210, a CXL Type 2 device 220 or a CXL Type 3 device 230. The type of CXL device may be determined by a CXL protocol supported by the CXL device.

The CXL device may support at least one CXL protocol (or CXL sub-protocol) (e.g., CXL.io, CXL.cache and/or CXL.mem). CXL.io may be an input/output (I/O) protocol based on a PCIe interface. CXL.io may be used to identify a device or establish a connection between devices. CXL.cache may be a protocol for securing cache coherency. For example, when devices share data with each other, CXL.cache may ensure that respective cache memories of each device have the same state. CXL.mem may be a protocol for supporting access to memory resources. CXL.io, CXL.cache or CXL.mem may be common protocols used in CXL, and thus a detailed description thereof is omitted.

The CXL Type 1 device 210 may support CXL.io and CXL.cache. Type 1 may be a CXL device (e.g., a domain-specific accelerator) not including memory.

The CXL Type 2 device 220 may support CXL.io, CXL.cache and CXL.mem. For example, type 2 may be a graphics processing unit (GPU) including memory.

The CXL Type 3 device 230 may support CXL.io and CXL.mem. For example, type 3 may be a memory expansion device including an I/O controller and a memory module.

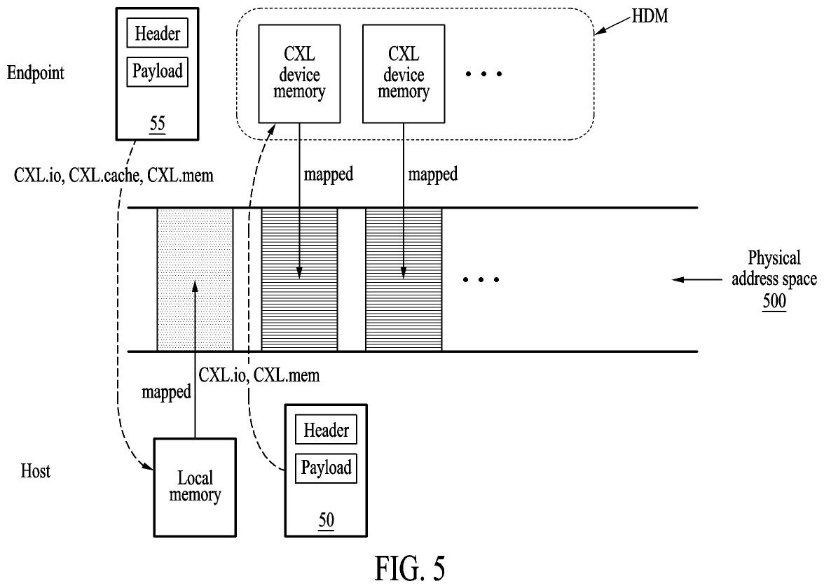

When a plurality of CXL devices (e.g., memory expansion devices) are connected to a host via CXL, the plurality of CXL devices may operate as a memory pool. In a CXL system (e.g., the CXL system 100 of FIG. 2), respective memories of a host (e.g., the host 110 of FIG. 2) and an endpoint (e.g., the at least one of the endpoints 131 to 135 of FIG. 2) may be mapped to the same physical address space (or integrated physical address space) (e.g., a physical address space 500 of FIG. 5). A CXL protocol (e.g., CXL.mem) may be used to map the memories to the same physical address space. Through this mapping, the CXL device may access memory of another CXL device. For example, the host may access memory of the endpoint, or the endpoint may access memory of the host or memory of another endpoint.

In a CXL system, the physical address space may be referred to as a host physical address (HPA) space, and the memory of the CXL device mapped to the physical address space may be referred to as HDM (e.g., HDM of FIG. 5). The physical address space is further described with reference to FIG. 5.

The host may access a CXL capability register and/or a designated vendor-specific extended capability (DVSEC) CXL capability register to acquire information on HDM of the endpoint. For example, the host may determine whether the endpoint includes the HDM via Mem_Capable and/or HDM_Count of the DVSEC CXL capability register. When the endpoint includes the HDM, the host may identify the number of HDMs included in the endpoint via a Mem_Capable field and/or HDM_Count field of the DVSEC CXL capability register. For example, the host may identify the size of the HDM included in the endpoint via a Memory_Size field of the DVSEC CXL capability register.

FIGS. 4 and 5 are diagrams illustrating a connection between a host and an endpoint according to an embodiment.

Referring to FIGS. 4 and 5, according to an embodiment, the host 110 and the endpoint 131 may communicate over Ethernet based on CXL, which may be referred to herein as “Ethernet-over-CXL”.

A container orchestrator may typically use Ethernet to communicate with a node. According to an embodiment, for communication (or data transfer) between the host 110 and the endpoint 131, as Ethernet-over-CXL is applied, the host 110 may use a container orchestrator (e.g., Kubernetes) using Ethernet for communication with the node for a CXL system (e.g., the CXL system 100 of FIG. 2) without changing the container orchestrator.

The host 110 may use the CXL connection to transmit an Ethernet packet to the endpoint 131 without an additional network interface card (e.g., hardware device).

The host 110 may generate an Ethernet frame 50 using an operating system kernel of the host 110. An Ethernet frame 50 may include a payload and a header. The Ethernet frame 50 may include data to be transmitted from the host 110 to the endpoint 131 and information (e.g., an internet protocol (IP) address of the endpoint 131) required to transmit the data.

The host 110 may use the physical address space 500 (e.g., HPA space) to transmit the Ethernet frame 50 to the endpoint 131. The host 110 may use the physical address space 500 to copy (or transmit) the Ethernet frame 50 to memory of the endpoint 131. The host 110 may use at least one CXL protocol (e.g., CXL.io and/or CXL. Mem) to transmit the Ethernet frame 50 to the endpoint 131.

The endpoint 131 may generate an Ethernet frame 55 to transmit data to the host 110. The generation of the Ethernet frame by the endpoint 131 may be similar to the generation of the Ethernet frame by the host 110, so a repeated description thereof is omitted. The endpoint 131 may use at least one CXL protocol (e.g., CXL.io, CXL.cache, and/or CXL.mem) to transmit the Ethernet frame 55 to the host 110.

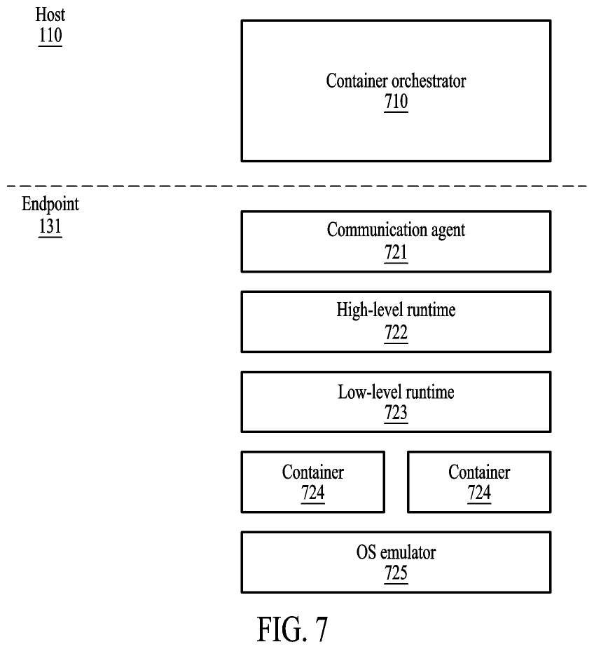

According to an embodiment, the operating system kernel of the host 110 and an operating system (OS) emulator (e.g., an OS emulator 725 of FIG. 7) of the endpoint 131 may respectively include a driver (e.g., a software driver) for exchanging an Ethernet frame based on a CXL connection (or a CXL protocol). The driver may assign individual IPs to each of at least one of the endpoints to identify the at least one of the endpoints (e.g., the at least one of the endpoints 131 to 135 of FIG. 1) connected to the host 110. For example, an IP address assigned to a first endpoint (e.g., the endpoint 131) and an IP address assigned to a second endpoint (e.g., the endpoint 132) may be different.

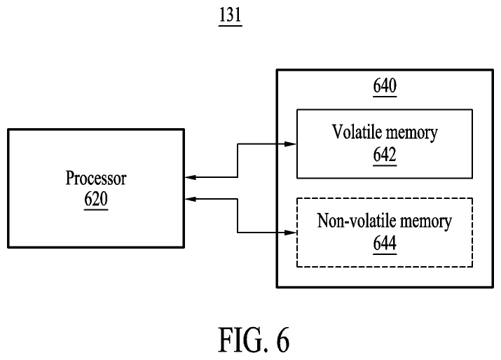

FIG. 6 is a schematic block diagram illustrating an endpoint according to an embodiment.

Referring to FIG. 6, according to an embodiment, the endpoint 13 may include a processor 620 and memory 640 (e.g., the CXL device memory of FIG. 5)

The processor 620 may execute software (e.g., a program or code) to control at least one other component (e.g., a hardware component and/or a software component) of an endpoint connected to the processor 620, or to perform data processing or operations. The processor 620 may include a main processor (e.g., a central processing unit (CPU) or an application processor (AP)), an auxiliary processor (e.g., a communication processor (CP), a GPU or a neural processing unit (NPU)) operable independently or in conjunction with the main processor, and/or a computing unit (e.g., a field programmable gate array (FPGA)).

The processor 620 may collectively, individually or selectively execute software (e.g., software modules 721 to 725 of FIG. 7), code, instructions and/or an application stored in the memory 640 to cause the endpoint 131 to perform at least one operation.

The memory 640 may store various data used by a component (e.g., the processor 620) of the endpoint 131. For example, the memory 640 may store software, an instruction, code, input data and/or output data.

The memory 640 may include at least one volatile memory 642 (e.g., dynamic random access memory (DRAM), high bandwidth memory (HBM) and/or static random access memory (SRAM)) and at least one non-volatile memory 644 (e.g., read-only memory (ROM), flash memory, a solid-state drive (SSD) and/or a hard disk drive (HDD)). In an embodiment, the non-volatile memory 644 may not be included in the endpoint 131.

The memory 640 may be non-transitory media. The term “non-transitory” may indicate that a storage medium is not implemented as a carrier wave or a propagated signal. However, the term “non-transitory” should not be construed as the memory 640 not being able to be moved.

FIG. 6 is a schematic block diagram illustrating the structure of the endpoint 131, and it is apparent to one of ordinary skill in the art that the endpoint 131 may further include at least one component other than the processor 620 and the memory 640. For example, the endpoint 131 may further include at least one component such as a CXL controller configured to manage a CXL connection, a memory controller (e.g., a double data rate (DDR) controller or a flash controller) configured to manage memory, and/or a communication module.

FIG. 7 is a diagram illustrating a software module of a host and a software stack of an endpoint according to an embodiment.

Referring to FIG. 7, according to embodiment, the host 110 may include a container orchestrator 710. The container orchestrator 710 may be a component for operating system-level virtualization. Operating system-level virtualization may provide the same execution environment for applications regardless of specifications of hardware running the application. The container orchestrator 710 may be a software module (or program code) for deploying, managing, scaling, monitoring and/or recovering a container (or a containerized application).

The host 110 may run an application within a container 724 based on a user command (or a user input), and manage the container 724 via the container orchestrator 710.

The endpoint 131 may include the software modules 721 to 725 required to run the container 724 under management of the container orchestrator 710. At least one of the software modules 721 to 725 may be firmware. For example, each of the software modules 721 to 725 may be firmware.

A communication agent 721 may receive data (e.g., a user command and/or additional data required to process the user command) including information on a user command from a host. As described with reference to FIGS. 4 and 5, communication between the host 110 and the endpoint 131 may be performed over Ethernet based on a CXL connection (or CXL protocol).

The communication agent 721 may transmit the data received from the host to a high-level runtime 722. For example, the communication agent 721 may call an API provided by the high-level runtime 722 to transmit the data to the high-level runtime 722. The high-level runtime 722 may provide the API according to a container runtime interface.

The communication agent 721 may be implemented as firmware so that the communication agent 721 may be executed without an operating system.

The high-level runtime 722 may be a high-level interface (e.g., a container). The high-level runtime 722 may manage creation of a container and/or execution of a container.

The high-level runtime 722 may acquire (or pull) a container image and manage a container image. For example, the high-level runtime 722 may download a container image from a container registry such as Docker Hub. The container image may be a package (e.g., a read-only package) including a file, library, setting and/or dependency required to run an application.

The high-level runtime 722 may transmit the container image to a low-level runtime. The high-level runtime 722 may be implemented as firmware so that the high-level runtime 722 may be executed without an operating system.

A low-level runtime 723 may be a low-level interface (e.g., runc). The low-level runtime 723 may run a container (or a container process) directly using the container image. The low-level runtime 723 may follow an open container initiative (OCI) runtime specification and/or an image specification.

The low-level runtime 723 may be implemented as firmware so that the low-level runtime 723 may be executed without an operating system.

The OS emulator 725 may emulate a function of an operating system (e.g., Linux, windows server or VMware ESXi) of the host 110. To run the container 724, a function of the operating system may be required, and the OS emulator 725 may provide the function of the operating system required to run the container 724 without the operating system. For example, the OS emulator 725 may perform at least one system call that may be called by the container 724 without an operating system. For example, the OS emulator 725 may provide a “brk( )” system call function for managing a memory region (e.g., a stack or hip) used by a container.

According to an embodiment, the endpoint 131 may run the container 724 without an operating system using the software modules 721, 722, 723 and 725.

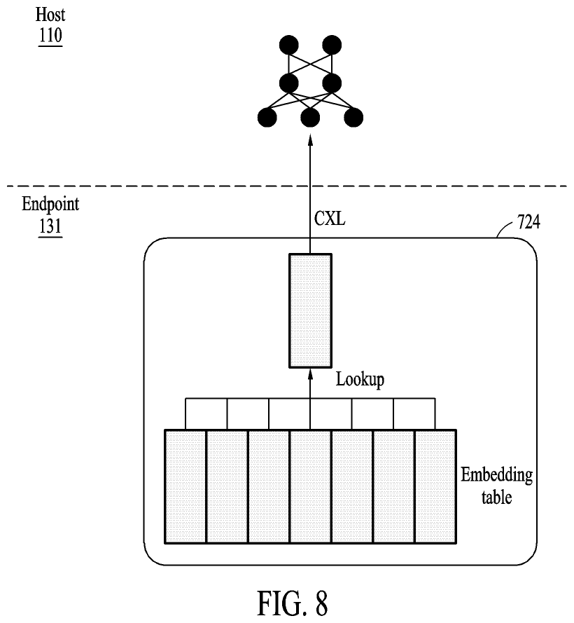

FIG. 8 is a diagram illustrating an example of an operation using a system according to an embodiment.

Referring to FIG. 8, according to an embodiment, a CXL system (e.g., the CXL system 100 of FIG. 2) may be used for a deep learning application (e.g., a machine learning application). However, FIG. 8 is only an example for describing the disclosure, and the extent to which the disclosure is applicable is not limited thereto.

A recommendation system may be an example of a deep learning-based application. In a recommendation system, an embedding vector may be a compressed representation of information on a preferred item (e.g., a movie, book, or product) of a user.

The host 110 may acquire a user command from the user and transmit data including information on the user command to the endpoint 131. For example, the user may provide a container orchestration API (e.g., a unified container orchestration API or a common container orchestration API) to the host 110 to request an NDP operation. For example, the host 110 may acquire a user request (e.g., a movie recommendation) for a recommendation system from a container orchestration API command user and deploy a container for performing an embedding operation of the recommendation system to at least one node.

Among at least one the endpoints connected to the host 110 (e.g., at least one of the endpoints 131 to 135 of FIG. 2), one or more endpoints may run a container to process a user command. For example, the host 110 may directly select at least one endpoint (e.g., the endpoint 131) to execute a container to process a user command from among at least one of the endpoints connected to the host 110. For example, a user may designate an endpoint (e.g., endpoint 131) to run a container to process a user command from among at least one of the endpoints connected to the host 110 via a user command.

The endpoint 131 may look up a target embedding vector from an embedding table stored in a CXL memory pool. While an embedding table is large in size, a lookup operation may require relatively light computational resources. Therefore, a lookup operation of a recommendation system may be a workload suitable for processing based on NDP.

The endpoint 131 may perform a lookup operation via the container 724. The endpoint 131 may transmit result data (e.g., a new embedding vector) generated from the lookup operation to the host 110. The endpoint 131 may use an Ethernet frame (e.g., the Ethernet frame 55 of FIG. 5) to transmit the result data.

The host 110 may process the result data received from the endpoint 131 using a neural network (e.g., a multi-layer perceptron) to provide a response (e.g., a movie recommendation) to the user.

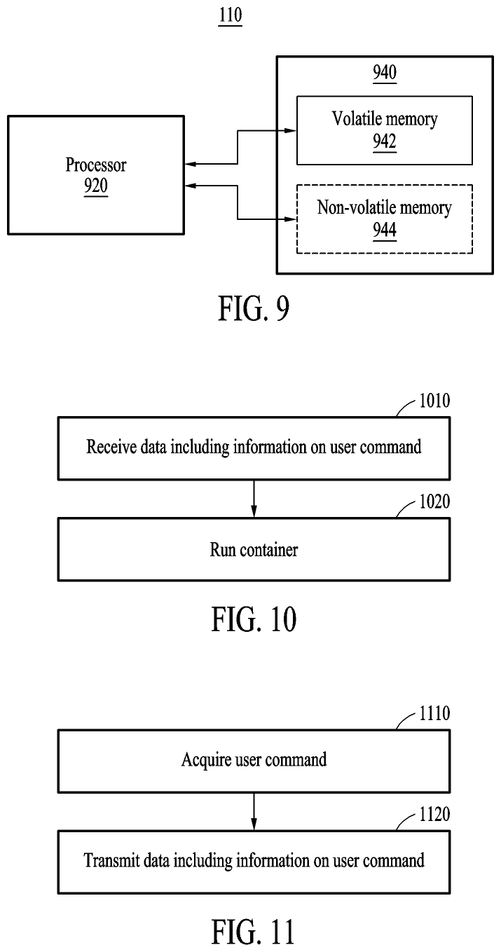

FIG. 9 is a schematic block diagram illustrating a host according to an embodiment.

Referring to FIG. 9, according to an embodiment, the host 110 may include a processor 920 and memory 940 (e.g., the host memory of FIG. 5).

The processor 920 may execute software (e.g., a program or code) to control at least one other component (e.g., a hardware component and/or a software component) of an endpoint connected to the processor 920, or to perform data processing or operations. The processor 920 may include a main processor (e.g., a CPU or an AP), an auxiliary processor (e.g., a CP, a GPU or an NPU) operable independently or in conjunction with the main processor, and/or a computing unit (e.g., an FPGA).

The processor 920 may collectively, individually, or selectively execute software (e.g., the container orchestrator 710 of FIG. 7), code, instructions, and/or applications stored in the memory 940 to cause the host 110 to perform at least one operation.

The memory 940 may store various data used by a component (e.g., the processor 920) of the host 110. For example, the memory 940 may store software, an instruction, code, input data, and/or output data.

The memory 940 may include at least one volatile memory 942 (e.g., DRAM, HBM, and/or SRAM) and at least one non-volatile memory 944 (e.g., ROM, flash memory, an SSD, and/or HDD). In an embodiment, the non-volatile memory 944 may not be included in the host 110.

The memory 940 may be non-transitory media. The term “non-transitory” may indicate that a storage medium is not implemented as a carrier wave or a propagated signal. However, the term “non-transitory” should not be construed as the memory 940 not being able to be moved.

FIG. 9 is a block diagram illustrating a schematic structure of the endpoint 131, and it is apparent to one of ordinary skill in the art that the endpoint 131 may further include at least one component other than the processor 920 and the memory 940. For example, the host 110 may further include a component (e.g., a CXL route complex) for managing interaction between the host 110 and a CXL device (e.g., at least one of the endpoints 131 to 135 of FIG. 2) connected to the host 110.

FIG. 10 is a flowchart illustrating an operation of an endpoint according to an embodiment.

Referring to FIG. 10, according to an embodiment, operations 1010 and 1020 may be performed sequentially, but embodiments are not limited thereto. Operation 1010 or operation 1020 may be substantially identical to the operation of the endpoint 131 described with reference to FIGS. 2 to 9, and therefore, a repeated description thereof is omitted.

In operation 1010, an endpoint device (e.g., the endpoint 131) may receive data including information on a user command from a host device (e.g., the host 110 of FIG. 2, FIG. 4, FIG. 7, FIG. 8, or FIG. 9). For example, the endpoint device may receive an Ethernet frame (e.g., the Ethernet frame 50 of FIG. 5) from the host device. The Ethernet frame may include a user command, data (e.g., program code and additional information) required to process the user command, and/or information (e.g., an IP address and/or a media access control (MAC) address) on an address of the endpoint device.

In operation 1020, the endpoint device may run a container using at least one of a first runtime software module (e.g., the high-level runtime 722 of FIG. 7) and a second runtime software module (e.g., the low-level runtime 723 of FIG. 7) to perform an operation corresponding to the user command. The container may use an emulator software module (e.g., the OS emulator 725 of FIG. 7) configured to emulate a function of an operating system (e.g., Linux) of the host device to perform the operation corresponding to the user command.

FIG. 11 is a flowchart illustrating an operation of a host according to an embodiment.

Referring to FIG. 11, according to an embodiment, operations 1110 and 1120 may be performed sequentially, but embodiments are not limited thereto. Operation 1110 or operation 1120 may be substantially identical to the operations of the host 110 described with reference to FIGS. 2 to 9, and therefore, a repeated description thereof is omitted.

In operation 1110, a host device may acquire a user command. For example, the host device may acquire a user command requesting the host device to recommend an item (e.g., a movie) suitable to the user.

In operation 1020, the host device may transmit data including information on the user command to an endpoint device (e.g., the endpoint 131 of FIG. 2, FIG. 4, FIG. 6, FIG. 7, or FIG. 8). For example, the host device may encapsulate the user command and data required for the user command into an Ethernet frame (e.g., the Ethernet frame 50 of FIG. 5). The Ethernet frame generated by the host device may include the user command, data (e.g., program code and additional information) required to process the user command, and/or information (e.g., an IP address and/or a MAC address) on an address of the endpoint device.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as ROM, random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

The effects that may be obtained from the present disclosure are not limited to the effects mentioned above, and other effects that are not mentioned may be clearly understood by one of ordinary skill in the art from the present disclosure.

What is claimed is:

1. A compute express link (CXL) device, comprising:
at least one processor including processing circuitry; and
at least one memory storing instructions that, when executed by the at least one processor individually or collectively, cause the CXL device to:
receive data comprising information on a user command from a host device, and
run a container using at least one of a first runtime software module and a second runtime software module to perform an operation corresponding to the user command,
wherein the container uses an emulator software module configured to emulate a function of an operating system of the host device to perform the operation corresponding to the user command.

2. The CXL device of claim 1, wherein
the CXL device provides memory resources of the CXL device to the host device based on CXL.

3. The CXL device of claim 1, wherein
the CXL device communicates with the host device via Ethernet based on a CXL protocol.

4. The CXL device of claim 3, wherein
the instructions, when executed by the at least one processor individually or collectively, cause the CXL device to:
receive an Ethernet frame comprising data comprising the information on the user command from the host device, based on the CXL protocol.

5. The CXL device of claim 1, wherein
each of the first runtime software module, the second runtime software module, and the emulator software module is firmware.

6. The CXL device of claim 1, wherein
the emulator software module is configured to provide a system call function for managing a region of the memory allocated to the container.

7. The CXL device of claim 1, wherein
the CXL device further comprises non-volatile memory configured to store data.

8. The CXL device of claim 7, wherein
the instructions, when executed by the at least one processor individually or collectively, cause the CXL device to:
perform the operation corresponding to the user command using the data stored in the non-volatile memory via the container.

9. The CXL device of claim 8, wherein
the instructions, when executed by the at least one processor individually or collectively, cause the CXL device to:
transmit result data generated from the operation corresponding to the user command to the host device.

10. The CXL device of claim 1, wherein
the CXL device is selected by the host device as a device to run the container for the user command among a plurality of CXL devices connected to the host device based on Ethernet.

11. The CXL device of claim 1, wherein
the CXL device supports a CXL.mem protocol.

12. The CXL device of claim 9, wherein
the emulator software module comprises a software driver configured to transmit the result data generated from the operation corresponding to the user command to the host device via an Ethernet frame.

13. The CXL device of claim 1, wherein
the instructions, when executed by the at least one processor individually or collectively, cause the CXL device to:
pull a container image via the first runtime software module, and
run the container using the container image via the second runtime software module.

14. A computing system based on compute express link (CXL), the computing system comprising:
the CXL device of claim 1; and
a host device configured to communicate with the CXL device via Ethernet based on a CXL protocol,
wherein the host device comprises:
at least one processor including processing circuitry; and
at least one memory storing instructions that, when executed by the at least one processor individually or collectively, cause the host device to:
acquire a user command, and
select a CXL device to run a container to process the user command among a plurality of CXL devices communicating with the CXL device via Ethernet based on a CXL protocol,
wherein respective internet protocol (IP) addresses of the plurality of CXL devices are different from each other.

15. An operating method of a compute express link (CXL) device, the operating method comprising:
receiving an Ethernet frame comprising data comprising information on a user command from a host device, based on a CXL protocol; and
running a container using at least one of a first runtime software module and a second runtime software module to perform an operation corresponding to the user command,
wherein the container uses an emulator software module configured to emulate a function of an operating system of the host device to perform the operation corresponding to the user command.

16. The operating method of claim 15, wherein
the CXL device provides memory resources of the CXL device to the host device based on CXL.

17. The operating method of claim 15, wherein
each of the first runtime software module, the second runtime software module, and the emulator software module is firmware, and
the emulator software module is configured to provide a system call function for managing a memory region of the CXL device allocated to the container.

18. The operating method of claim 15, wherein
the CXL device further comprises non-volatile memory configured to store data.

19. The operating method of claim 18, further comprising:
performing the operation corresponding to the user command using the data stored in the non-volatile memory via the container; and
transmitting result data generated from the operation corresponding to the user command to the host device.

20. The operating method of claim 15, wherein
the CXL device supports a CXL.mem protocol.

21. The operating method of claim 15, wherein
the emulator software module comprises a software driver configured to transmit result data generated from the operation corresponding to the user command to the host device via an Ethernet frame.
